(19) United States
(12) Patent Application Publication
(10) Pub. No.: US 2004/0015890 A1
(43) Pub. Date: Jan. 22, 2004

(54) System and method for adapting files for backward compatibility

(75) Inventors: Edwin Wong, Calgary (CA); Liem Trinh, Calgary (CA); Julian Bromwich, Calgary (CA)

Correspondence Address: FAY KAPLUN & MARCIN, LLP, 15O BROADWAY, SUITE 702, NEW YORK, NY, 10038, US

(73) Assignee: WindRiver Systems, Inc.

(21) Appl. No.: 09/854,111

(22) Filed: May 11, 2001

(51) Int. Cl. G06F 9/45

(52) U.S. Cl. 717/137; 717/143

(57) ABSTRACT

A software package, comprising a receiving module determining a format of each of a plurality of original files and a converter module applying a converter function corresponding to the file format of each of the original files to create new files in a converted file format.

### BACKGROUND INFORMATION

Devices such as personal computers (“PCs”), personal digital assistants (“PDAs”), embedded devices, etc., that contain processors or controllers have an operating system which is the main control program that schedules tasks, manages storage, and handles communication with peripherals. Additionally, application programs may be loaded on these devices to perform specific tasks such as word processing, web page display, electronic mail, etc. The developers of operating systems and application programs are constantly improving the functionality of the software by, for example, adding features to the software. When the developer has improved the functionality of the software, generally there is a new release or version of the software that is made available to the public embodying the new functionality.

The new release may have different properties, for example, file structures, protocols, formats, layouts, etc. from the previous releases of the software. One of the goals of the developer may be to ensure that the new release is backwards compatible, meaning that the new release is compatible with (e.g., can share data with) earlier versions of the software. Backwards compatibility may also mean that the new release is compatible with other earlier systems, particularly systems the new software intends to supplant. A backwards compatible change allows old versions to coexist without crashes or error messages. However, too many major changes incorporating elaborate backwards compatibility processing can lead to extreme software bloat which is the result of adding new features to software to the point where the benefit of the new features is outweighed by the extra resources consumed (e.g., random access memory “RAM”, flash memory, performance, etc.) and complexity of use.

Thus, backwards compatibility is a key consideration when developers are designing new software releases or new software to replace existing software packages. The developer must balance the need to access existing files and data against overburdening the software and device resources with extraneous code and functionality that does not provide a corresponding benefit to the user of the system.

### SUMMARY OF THE INVENTION

A software package, comprising a receiving module determining a format of each of a plurality of original files and a converter module applying a converter function corresponding to the file format of each of the original files to create new files in a converted file format. Further, a system, comprising an application module to perform functions, the application module uses information contained in a configuration file to perform the functions and a conversion module converting the configuration file from a first format incompatible with the application module to a second format compatible with the application module.

### BRIEF DESCRIPTION OF DRAWINGS

FIG. 1 shows an exemplary DOM tree haying a root node and child nodes;

FIG. 2a shows a first exemplary system for accessing configuration file information by an application program according to the present invention;

FIG. 2b shows a second exemplary system for accessing configuration file information by an application program according to the present invention;

FIG. 3 shows an exemplary block diagram for adapting configuration files for use with an application program according to the present invention;

FIG. 4 shows two tables illustrating exemplary information contained in two configuration files;

FIG. 5 shows an exemplary DOM tree that may be the output of a DOM converter based on an input of exemplary manifest files according to the present invention;

FIG. 6 shows an exemplary process for converting a configuration file into a DOM tree according to the present invention;

FIG. 7 shows an exemplary block diagram for a DOM converter according to the present invention.

### DETAILED DESCRIPTION

The present invention may be further understood with reference to the following description of preferred exemplary embodiments and the related appended drawings, wherein like elements are provided with the same reference numerals. The software architecture of a program or computing system is the structure or structures of the system, which comprise software components, the externally visible properties of those components, and the relationships among them. “Externally visible” properties are those assumptions other components can make of a component, such as its provided services, performance characteristics, fault handling, shared resource usage, etc. A piece of the software architecture may be a configuration file which contains information for the particular software program. When the program is executed, it consults the configuration file to determine which parameters are in effect and the program is executed in accordance with these parameters. Those skilled in the art will understand that there may be files having other names (e.g., definition files, manifest files, etc.) that perform the same functions as those described for the configuration files. The preferred embodiment of the present invention will be described in reference to configuration files, but may be used to manipulate data in any type of file so that the information contained in the file is available for use by software programs independent of the original format of the data file.

An example of a generic file format is the Document Object Model (“DOM”) which specifies a tree based representation based on other file types, e.g., eXtensible Markup Language (“XML”) DOM is useful in representing document files which are a common manner of implementing configuration files. Those skilled in the art will understand that the document files may be in various file formats and that the present invention is not limited to document files. Those interested in additional detail concerning DOM are directed to the “Document Object Model (DOM) Level 1 Specification”, Document REC-DOM-Level-1-19981001 by the World Wide Web Consortium (“W3C”).

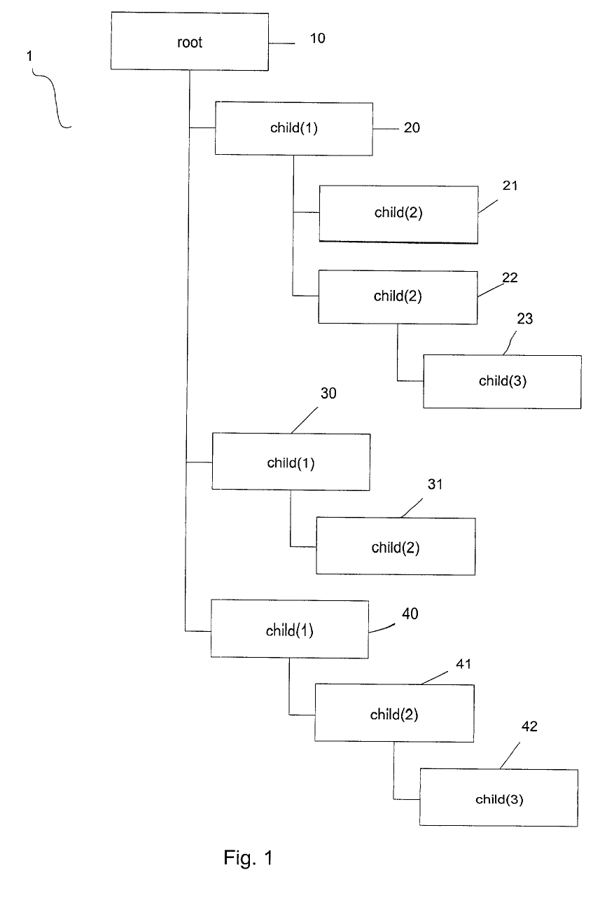

FIG. 1 shows an exemplary DOM tree 1 having root node 10 and child nodes 20-42. DOM tree 1 is a hierarchical representation of the information in a file. If the file is, for example, a configuration file, DOM tree 1 may contain information relating to the initial settings for program parameters, pointer to help files, etc. All of the nodes of DOM tree 1 lead back to root node 10. In exemplary DOM tree 1, root node 10 has three child(1) nodes 20, 30 and 40 on the first level under root node 10. Child(1) node 20 has two child(2) nodes 21 and 22, child(1) node 30 has one child(2) node 31 and child(1) node 40 also has one child(2) node 41. Child(2) nodes 21, 22, 11 and 41 are on the second level under root node 10. Child(1) node 22 has one child(3) node 23 and child(2) node 41 has one child(3) node 42. Child(3) nodes 23 and 42 are on the third level under root node 10. Top level root node 10 may be, for example, the name of the configuration file. A program that is accessing this file may use root node 10 to gain access to the information in DOM tree 1. For example, the name of the file may be “config1,” thus root node 10 would have the name “config1”. An application program may need to access the information contained in the file “config1.” The application program may search the available DOM trees to find the tree having root node 10 “config1.” When the application program finds the correct DOM tree, it then may access the information contained in that file. Although the original “config1” file may not have been in the DOM tree format, it may have been converted to the DOM tree format prior to the application program attempting to access the file. This conversion and the application program access will be discussed in greater detail below.

The first level of child nodes, child(1) nodes 20, 30 and 40, may be the first level of content in the file, for example, parameter names. Thus, child(1) node 20 may be parameter1, child(1) node 30 may be parameter2 and child(1) node 40 may be parameter3. Each of the second level of child nodes, child(2) nodes 21, 22, 31 and 41 may be a second level of content containing information about the corresponding parent node. If, as in the example above, the parent nodes were parameter names, the child(2) nodes may indicate a type of the parameter or settings for the parameter. For example, child(2) node 41 may indicate that child(1) node 40 parameter3 is a boolean parameter. Each of the third level of child nodes, child(3) nodes 23 and 42 may be a third level of content containing information about the corresponding parent node. Following through with the above example, child(3) node 42 may indicate that an initial setting of child(1) node 40 parameter3, a boolean parameter based on the exemplary setting of child(2) node 41, is false. Those skilled in the art will understand that DOM tree 1 may have numerous command nodes that are nested to multiple levels. Exemplary DOM tree 1 has four levels of nesting: the first level contains root node 10; the second level contains child(1) nodes 20, 30, and 40; the third level contains child(2) nodes 21, 22, 31 and 41; and the fourth level contains child(3) nodes 23 and 42. However, it may be possible to go to much deeper levels of nesting by adding additional child nodes that are children, grandchildren, etc. of the existing child nodes. For example, adding child nodes and grandchild nodes to child(3) node 23 would result in nesting of DOM tree 1 to a sixth level. This may result in multiple branches on DOM tree 1, but all these branches will still start at root node 10. A specific example of a DOM tree will be described in detail below.

A benefit of representing file information using DOM tree 1 is that any application program may retrieve the information contained in the file because it is generic. The software functions to retrieve the information from a hierarchical tree structure are well known in the art. These software functions allow the application programs to traverse DOM tree 1 to access nodes and the information contained in such nodes. Following through with the example started above, an application program may need some information contained in the file “config1.” The application would search the available DOM trees to find one that had an attribute with the name “config1.” After finding the correct DOM tree, the application program may then need to know the initial value of parameter3. Using this example, the application program would traverse child(1) nodes 20, 30 and 40 until it finds the name parameter3 (child(1) node 40). The application program may then traverse the DOM tree branch of child(1) node 40 parameter3 to retrieve the requested information. In this example, the information would include that parameter3 is a boolean parameter (child(2) node 41) and that the initial value is false (child(3) node 42). This information may then be stored by the application program in system memory so that it may be used while the application program is executing. In an alternative example, the application program may require all the information in file “config1.” In this example, the application program may traverse all the branches of DOM tree 1 to access all the information in file “config1.” Those skilled in the art will understand that the use of a DOM tree in describing the present invention is only exemplary. The present invention may be implemented using a variety of file formats including other hierarchical tree formats and other types of generic file formats into which files may be transformed.

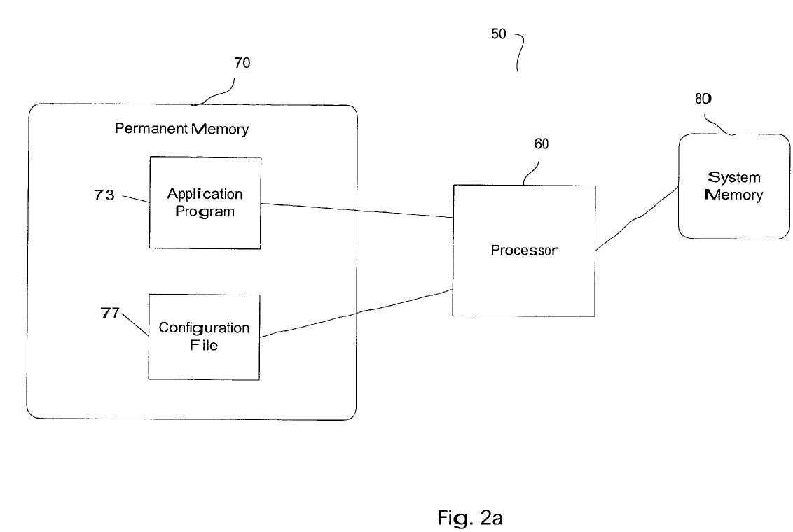

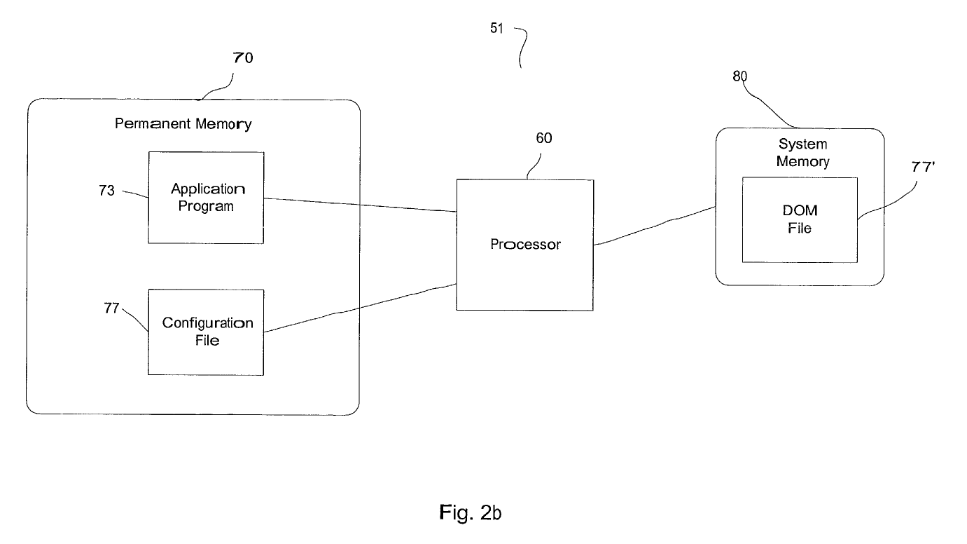

FIG. 2a shows a first exemplary system 50 for accessing configuration file 77 information by application program 73. Exemplary system 50 may be contained on any device containing a processor (e.g., personal computers (“PCs”), personal digital assistants (“PDAs”), embedded devices, etc.). FIG. 2a shows processor 60, permanent memory device 70 (e.g., hard disk, flash memory) and system memory 80 (e.g., random access memory (“RAM”)). Permanent memory 70 may store data and files that the user may wish to access while operating the device, for example, application program 73 and configuration file 77. System memory 80 may be short term memory which is typically erased each time the device is powered off or when processor 60 determines that it no longer needs the currently stored information. System memory 80 may hold instructions and data needed to complete certain tasks.

When processor 60 executes application program 73, processor 60 accesses permanent memory 70 and loads the data and instructions for application program 73 stored in permanent memory 70 into system memory 80 (for example, so that processor 60 can access the data and instructions of application program 73 more quickly). In order to start the execution of application program 73 or during the execution of application program 73, processor 60 may need the information stored in configuration file 77. If configuration file 77 is in a format that application program 73 expects, it may be loaded directly into processor 60 for use by application program 73. However, configuration file 77 may be in a format that application program 73 is not expecting and if configuration file 77 is not transformed, application program 73 may not have access to the information contained in configuration file 77.

For example, a user may have application program 73, called “Application 1.0,” which has configuration file 77 in a proprietary format developed by the seller of Application 1.0. Over time, the user may have altered configuration file 77 so that Application 1.0 operated in a manner consistent with the user's needs. The seller of Application 1.0 may release a new version of application program 73, called “Application 1.1,” which has configuration file 77 in XML format. The user may want to upgrade to the new version of application program 73, Application 1.1, but the user may not want to spend the time and effort to alter the new configuration file 77 (XML format) to make it consistent with the old configuration file 77 (proprietary format). Thus, the user may desire to continue using the old configuration file 77 (proprietary format) with Application 1.1. However, Application 1.1 will be expecting configuration file 77 to be in XML format and may not be able to access the information contained in configuration file 77 in the proprietary format. The present invention allows the seller of application program 73 to provide a method for backward compatibility of the configuration files.

As can be seen from the above example, configuration file 77 may be in a number of different file formats and contain information needed to execute application program 73. There may also be multiple configuration files 77 (in different file formats) having information for various aspects or functions of application program 73. FIG. 2b shows a second exemplary system 51 for accessing configuration file 77 information by application program 73. The difference between system 50 of FIG. 2a and system 51 of FIG. 2b is that configuration file 77 is transformed into a generic file format, in this example, a DOM file 77′. As previously described, the present invention is not limited to transforming the configuration files into DOM format, any file format may be used. Configuration file 77 may be transformed into DOM configuration file 77′ in the format of exemplary DOM tree 1 of FIG. 1. The transformation of configuration file 77 into DOM configuration file 77′ will be described in greater detail below. As illustrated by FIG. 2b, when configuration file 77 is transformed into DOM configuration file 77′, the latter may be stored in system memory 80. Following through with the above example, the user of application program 73 may continue to use the old configuration file 77 (proprietary format) because application program 73 will be expecting a DOM format and the old configuration file 77 (proprietary format) will be transformed into DOM file 77′. Thus, the original format of configuration file 77 is irrelevant to application program 73 as long as it may transform the file into DOM file 77′. Application program 73 may then continue to access the information stored in DOM file 77′ for proper operation of application program 73.

Those skilled in the art will understand that the transformation maybe carried out through instructions programmed into application program 73 or there may be a separate piece of software which carries out this transformation. Additionally, the DOM tree of DOM configuration file 77′ does not need to be resident in system memory 80, it may be stored in permanent memory 70. When DOM configuration file 77′ is stored in permanent memory 70, it may be possible to read new sections of DOM configuration file 77′ into system memory 80 as the sections are requested by application program 73. Also, it should be clear that since application program 73 is not dependent on the file format of configuration file 77, the file format selected for configuration file 77 may be any file format. For example, following through with the example started above, the developer of application program 73 in the version called Application 1.1 may still provide the configuration files in XML format. Thus, whether configuration file is in the old or new format (e.g., proprietary format or XML, respectively), application program 73 will still be expecting a DOM format. Both the old and the new configuration files will be transformed. The new configuration file 77 may also be originally in DOM format and then only the old configuration file will be transformed. A reason for not having the new configuration file in the format that application program 73 is expecting is that users may be more familiar with manipulating an XML file than a DOM tree and having configuration file 77 in XML format is more user friendly. The possibility also exists that the developer may wish to change the format of configuration file 77 to a more user friendly format without changing the internal workings of application program 73. Thus, each subsequent version of application program 73 may include configuration files 77 with different formats, but each version of application program 73 is still expecting to see the data in, for example, DOM format.

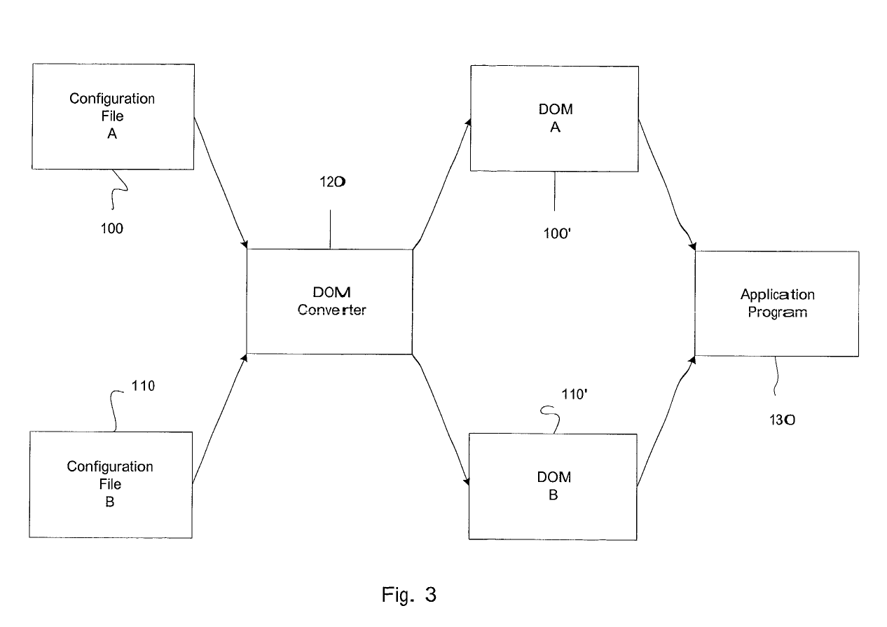

FIG. 3 shows an exemplary block diagram for adapting configuration files 100 and 110 for use with application program 110. Configuration files 100 and 110 may be in any number of formats, for example, XML, MIME, Java Properties files, etc. In this exemplary embodiment, configuration file A 100 and configuration file B 110 are in different file formats. As described above, there may be varying reasons for the different file formats. For example, configuration file B 110 may be from the current version of application program 130 while configuration file A 100 may be from an earlier version of application program 130. In this example application program 130 may use either or both of configuration file A 100 and configuration file B 110.

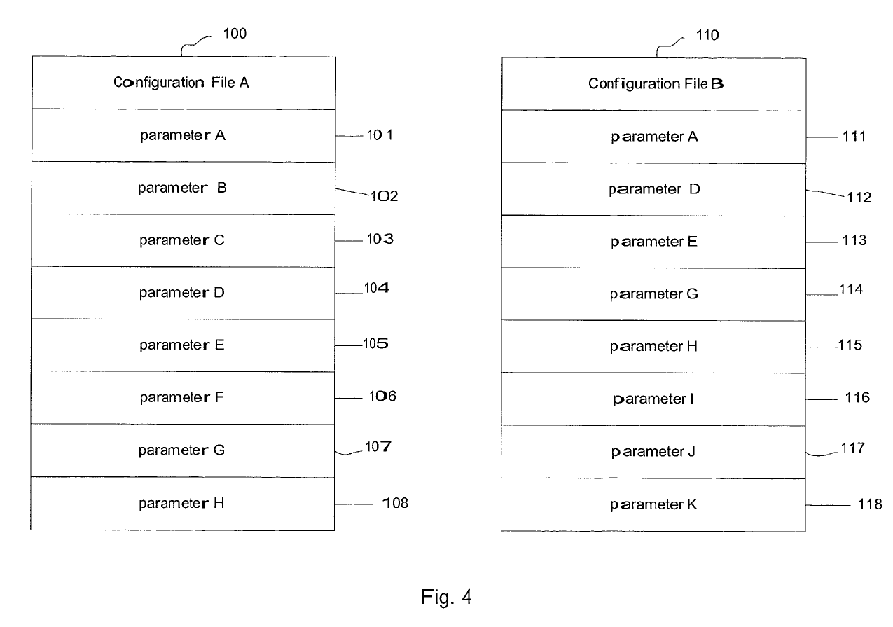

FIG. 4 shows two tables illustrating exemplary information contained in configuration file A 100 and configuration file B 110. Configuration file A 100 contains information relating to parameter A 101 through parameter H 108. Configuration file B 110 contains information relating to parameter A 101, parameter D 112, parameter E 113, and parameter G 114 through parameter K 118. As shown in FIG. 4, configuration file A 100 and configuration file B 110 share common information regarding parameters A, D, E, G and H. Thus, if application program 130 may use either of configuration file A 100 and configuration file B 110, then it may require the information for one or more of parameters A, D, E, G and H. In an alternative embodiment, it may also be possible that application program 130 may require different configuration information based on different modes of operation of application program 130, e.g., multi-user mode versus single-user mode. In such an embodiment, the information contained in configuration file A 100 and configuration file B 110, does not necessarily need to overlap. Those of skill in the art will understand that the tables in FIG. 4 do not connote any particular file format, but are only exemplary to show information that may be contained in one or both of configuration file A 100 and configuration file B 110.

Referring back to the block diagram of FIG. 3, configuration file A 100 and configuration file B 110 are input into DOM converter 120 which converts the formats and information into the DOM tree format. The resulting objects are DOM A 100′ from configuration file A 100 and DOM B 110′ from configuration file B 110. Those skilled in the art will understand that DOM A 100′ and DOM B 110′ may be, for example, objects, files, etc., stored in memory. DCM converter 120 may be instructions or functions within application program 130 or it may be a separate piece of software. The steps carried out by DOM converter 120 to convert a configuration file into a DOM file (e.g., configuration file A 100 to DOM A 100′) may be different based on the file format of the original configuration file. For example, if configuration file A 100 is an XML file, DOM converter 120 may use a parsing function to separate the XML file into its constituent textual parts and assemble DOM A 100′. Further examples of file conversions will be described in greater detail below.

Application program 130 may then retrieve all the information it may need from any one of DOM A 100′ or DOM B 110′ by traversing the DOM tree as described above. In this manner, application program 110 is independent of the configuration file format because all configuration files appear as DOM trees to application program 130. Thus, a developer may create the original configuration file in any file format. This also allows developers to change configuration file formats for new releases of application program 130 and continue to support previous configuration file formats allowing the newer releases of application program 130 to be backward compatible with previous releases. If the developer decides to change the configuration file format, DOM converter 120 would include a new function to convert the new file format into the DOM format. However, any previous converter functions may be retained, allowing application program 130 access to information in any of these previously supported formats. The code for the multiple converter functions is the only code required to support multiple configuration file formats and will not create software bloat in the new releases of application program 130. Additionally, a developer may choose to support multiple configuration file formats in addition to those from previous versions of the same application program 130. To accomplish this goal, the developer would include the converter functions in DOM converter 120 for the supported file formats. The code to retrieve the configuration information from the DOM tree does not need to be changed because this code is the same regardless of the format of the original configuration file.

The following are two examples of configuration files that may be used according to the preferred embodiments described herein and are referred to as manifest files. The first example is an XML manifest file from the WindStorm™ product sold by Wind River Systems, Inc. of Alameda, Calif. The second example is a manifest file from the Open Services Gateway Initiative (OSGi) which is an independent, non-profit corporation working to define and promote open specifications for the delivery of multiple services over wide-area networks to local networks and devices. The two examples of manifest files both contain the game information in describing an exemplary plug-in called “AWT Specific Classes,” but the format of the two manifest files is different.

### EXAMPLE 1

### XML Manifest File

<archive name = “AWT Specific Classes”>

<description>

Windstorm AWT application interfaces. Used to rapidly build
and deploy an AWT application within WindStorm.

</description>
<vendor> Wind River Systems </vendor>
<docURL> http://www.windriver.com </docURL>
<contactAddress> help@windriver.com </contactAddress>
<publicLibraryDescriptor name = “WindStorm AWT”
specificationVersion = “1.1.0”>

<export>

<package> com.windriver.ws.corex.awt </package>

</export>

</publicLibraryDescriptor>

</archive>

### EXAMPLE 2

### OSGi Manifest File

Bundle-Name: AWT Specific Classes
Bundle-Description: Windstorm AWT application interfaces. Used to

rapidly build. and deploy an AWT application
within WindStorm.

Bundle-Vendor: Wind River Systems
Bundle-DocURL: http://wxvw.windriver.com
Bundle-ContactAddress: help@windriver.com
Export-Package: com.windriver.ws.corex.awt; specification-version=1.1.0

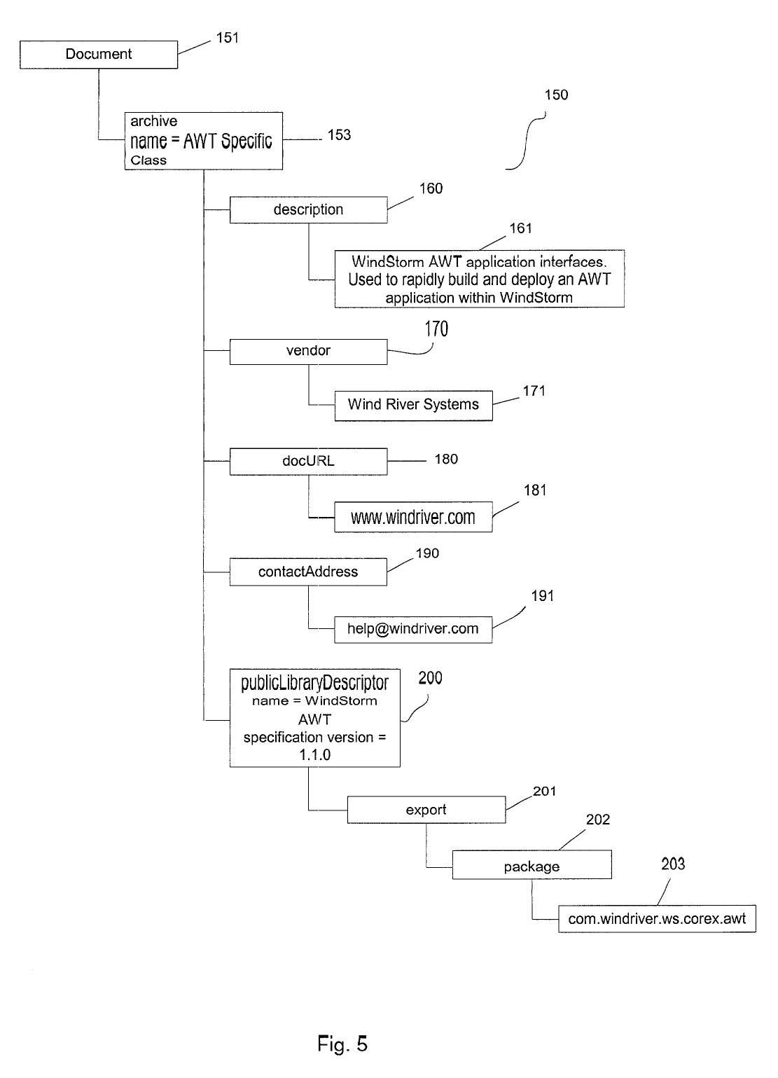

Each of these manifest files may be transformed by DOM converter 120 into DOM trees. FIG. 5 shows an exemplary DOM tree 150 that may be the output of DOM converter 120 upon input of either of the exemplary manifest files. As described above, both of the exemplary manifest files contain the same information about an exemplary plug-in called “AWT Specific Classes” in two different formats. Thus, it is possible that DOM tree 150 may be the output of DOM converter 120 regardless of which of the two exemplary manifest file it converts.

Referring to DOM tree 150 of FIG. 5, root node 151 indicates that the file is a document file. Archive node 153 includes the attribute name of the plug-in “AWT Specific Class” (i.e., the <archive name> of Example 1, the Bundle-Name of Example 2). As described above, if application program 130 needs the information contained in these manifest filch, it may search the archive nodes which it knows the location of, until it finds the archive node having a name attribute matching the desired plug-in. The first child node 160 on the first level under root node 151 is the description parameter of the plug-in and it contains the textual description in its child node 161 (i.e., <description> in Example 1, Bundle-Description in Example 2). The second child node 170 on the first level under root node 151 is the vendor parameter of the plug-in and it contains the name of the vendor in its child node 171 (i.e., <vendor> in Example 1, Bundle-Vendor in Example 2). The third child node 180 on the first level under root node 151 is the Uniform Resource Locator (“URL”) parameter for the vendor of the plug-in and it contains the URL address in its child node 181 (i.e., <docURL> in Example 1, Bundle-DocURL in Example 2). The fourth child node 190 on the first level under root node 151 is the contact address parameter for the vendor of the plug-in and it contains the electronic mail address of the vendor in its child node 191 (i.e., <contactAddress> in Example 1, Bundle-ContactAddress in Example 2).

Finally, the fifth and final child node 200 on the first level under root node 151 is the public library parameter of the plug-in. Public library node 200 hag two attributes and one child node 201. The first attribute of public library node 200 is the name of the public library (i.e., <. . . name=“WindStorm AWT . . .> in Example 1). Those skilled in the art will recognize that this attribute is not contained in Example 2 because it is not necessary that each attribute be contained, just those that are necessary to identify the node. In Example 2, the second attribute is sufficient to identify the node. The second attribute public library node 200 is the version of the specification (i.e., <. . . specificationVersion=“1.1.0”> in Example 1, specification-version=1.1.0 in Example 2). The child node 201 of public library node 200 is the export parameter which contains a child node 202 identifying the parameter as a package contained in its child node 203 (i.e., <export> and <package> in Example 1).

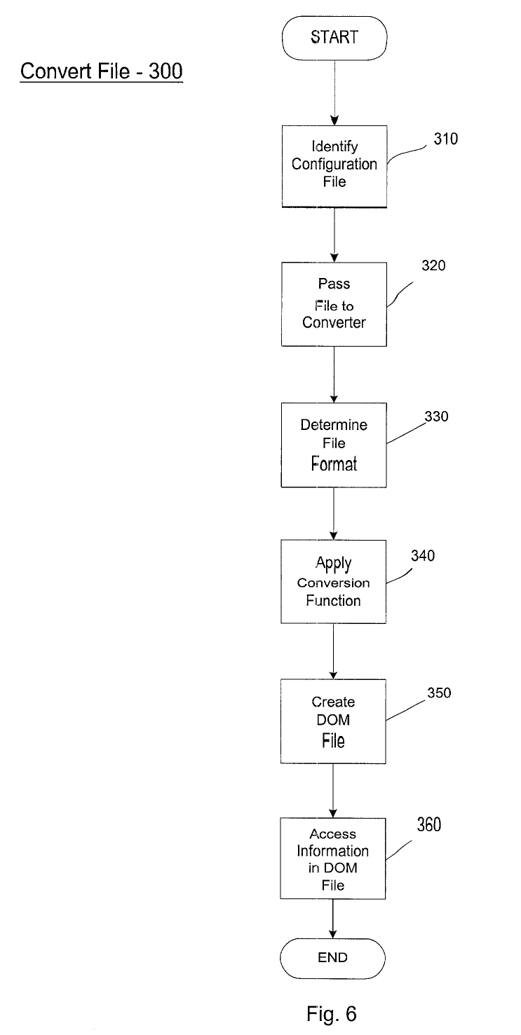

FIG. 6 shows an exemplary process 300 for converting a configuration file into a DOM tree. In step 310 the configuration file required by application program 130 (e.g., configuration file A 100) is identified. The configuration file may be identified by, for example, a reference in application program 130. In step 320 the configuration file is passed to DOM converter 120 which determines the file format of the configuration file in step 330. One method for determining the file format may be based on the file extension to determine the file format. Another method may be to store the formats of various files and compare the text (or other manner of describing the structure of the configuration file) to the stored formats to determine the file format of the configuration file. For example, Document Type Definition (“DTD”) defines the legal building blocks of an XML document including a list of legal elements that may be included in the structure. By reading the document and determining it is following the DTD rules, DOM converter 120 may determine that the configuration file is in an XML format and apply the correct conversion function in step 340. As described above, one manner of converting a configuration file into a DOM tree may be by using a parsing function to parse the file into its constituent parts so that it may be reassembled as a DOM tree. The parsing function may be effective for document files because they are text based. Referring back to Example 1, DOM converter 120 may have applied a parsing function to parse the exemplary XML manifest file into its constituent parts. The parsing function may have identified all the material between the open indicator <archive> and the close indicator </archive> and then continued to parse the information between corresponding open and close indicators in the file. The parsing function may also group the information contained between various open and close indicators based on the relationship between the information (e.g., if a set of open and close indicators is nested within another set of indicators). After applying the correct conversion function, DOM converter 120 may then create the DOM tree (e.g., DOM A 100′) in step 350. After the DOM tree has been created, application program 130 may access the information by traversing the DOM tree.

In an alternative embodiment, the configuration file (or the file that is to be converted) may be in some format that is not a document (e.g., a database file, a C++ file, etc.). In these cases, DOM converter 120 may employ different converting functions in order to convert the file from its original format to a DOM tree. For example, if the original file is a database file, DOM converter 120 may employ an extraction function to extract all the information from the database file including the field names and data into a document. After this, DOM converter 120 may again employ the parsing function to group the information in the document and then create a DOM tree from the information. Similarly, DOM converter 120 may convert the file directly from database format into a DOM tree.

Similarly, the desired output may not be a DOM tree, but some other generic file format that application programs may access information. In this case, DOM converter 120 would employ converter functions that convert files into the desired format. Using the example of a database file being the desired output, a converter function may take the information in a file (e.g., the XML manifest file of Example 1) and use the parsing function in the same manner as described above. The converter function may then import the parsed information into the corresponding fields in a database so that application programs may have access to this information.

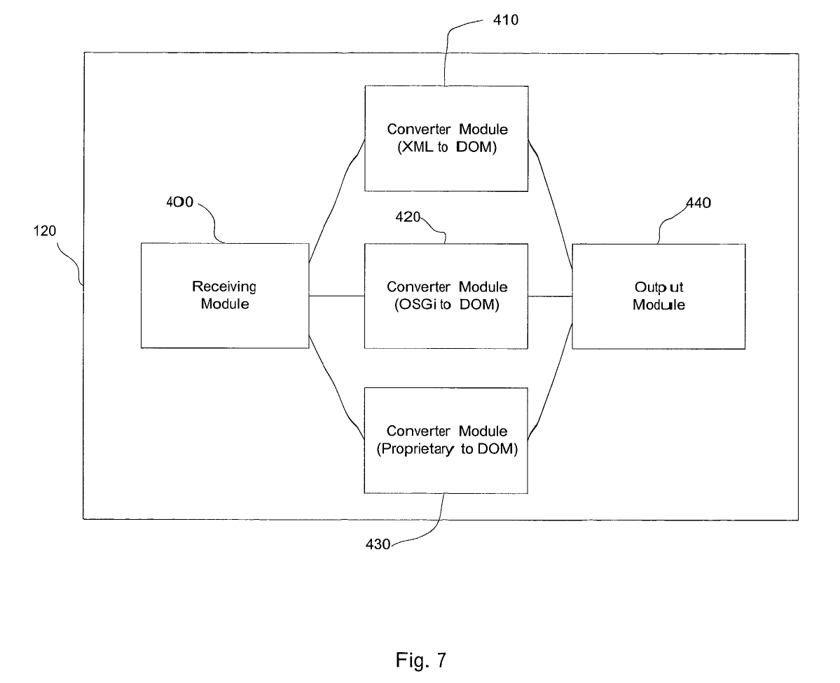

FIG. 7 shows an exemplary block diagram for DOM converter 120 having receiving module 400, converter modules 410-430 and output module 440. Receiving module 400 receives the configuration file desired by application program 130 (e.g., configuration file A 100) and identifies the format of the configuration file. For example, configuration file A 100 may be in XML format and receiving module 400 would identify the format as XML so that the file could be sent to the proper one of converter modules 410-430. The developer of DOM converter 120 may include any number of formats in receiving module 400 that can be identified based on the expected types of formats. For example, application program 130 may be in its fifth release version and there may be three file formats for configurations files that were used in one or more of the versions. To assure complete backward compatibility for each of these file formats, the developer may include code which identifies each of the three formats. Those skilled in the art will understand that there may be numerous methods for identifying the format of the configuration file, for example, by the file extension, by searching for keywords or symbols in the file, etc.

After receiving module 400 identifies the file format, it directs the configuration file to the correct one of converter modules 410-430. For example, converter module 410 is an XML format to DOM format converter, thus, configuration file A 100 would be directed to converter module 410. Configuration file A 100 would then be converted into DOM format (e.g., into DOM file A 100′) by converter module 410. Those skilled in the art will understand that converter modules 410-430 will contain code specific for the desired conversion. For example, converter module 410 may contain a standard text parser to parse the XML code and insert the parsed code into the DOM tree. In the case of XML code, the parser may be able to identify node information by extracting information contained between the start indicators < > and end indicators </>. Similarly, these indicators may also be used to determine the nesting of the information (i.e., whether a node is a child node of another node). In this manner the information contained in the XML file may be inserted in the correct hierarchical order into the DOM tree. In the example of FIG. 7, there are two additional converter modules, converter module 420 for converter OSGi format into DOM format and converter module 430 for converting a proprietary format into DOM format. When converter modules 410-430 have completed converting the file, the file is sent to output module 440 which prepares the file for use by the application program 130.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A software package, comprising:
a receiving module determining a format of each of a plurality of original files; and
a converter module applying a converter function corresponding to the file format of each of the original files to create new files in a converted file format.

2. The software package according to claim 1, further comprising:
an application program to access information in the new files, wherein the application program is compatible with the new files and incompatible with the original files.

3. The software package according to claim 1, wherein the converted file format is a document object model tree.

4. The software package according to claim 1, wherein the converter function includes a text parser.

5. The software package according to claim 1, wherein the original files include a configuration file.

6. The software package according to claim 1, wherein the receiving module determines the format of the original files based on file extensions.

7. A system, comprising:
an application module to perform functions, the application module uses information contained in a configuration file to perform the functions; and
a conversion module converting the configuration file from a first format incompatible with the application module to a second format compatible with the application module.

8. The system according to claim 7, wherein the conversion module includes a plurality of converter functions corresponding to a plurality of file formats, the first format being one of the plurality of file formats.

9. The system according to claim 8, wherein the conversion module includes a receiving element to determine the first format.

10. The system according to claim 7, wherein the second format is a document object model tree.

11. The system according to claim 7, wherein the first format is an extensible markup language.

12. A method of converting an original file from a plurality of formats, comprising the steps of:
reading a format of the original file;
applying to the original file a converter function corresponding to the format of the original file; and
saving the original file in a new file which is in a converted file format created by the application of the corresponding converter function.

13. The method of claim 12, further comprising the step of:
outputting the new file to an application program which uses information in the new file to configure the application program, wherein the application program is compatible with the new file and incompatible with the original file.

14. The method of claim 12, wherein the converted file format is a document object model tree.

15. The method of claim 12 wherein the plurality of formats of the original files include an extensible markup language.

16. The method of claim 12, wherein the new files are saved in one of random access memory and permanent memory.
